(19) United States
(12) Patent Application Publication
(10) Pub. No.: US 2010/0299758 A1
(43) Pub. Date: Nov. 25, 2010

(54) METHOD AND DATA SHARING SYSTEM IN PEER TO PEER ENVIRONMENT

(75) Inventors: Eun Hee Hyun, Daejeon (KR); Sung Hee Kim, Daejeon (KR); Cheol Hye Cho, Daejeon (KR); Young Jick Bahg, Daejeon (KR)

Correspondence Address: RABIN & Berdo, PC, 1101 14TH STREET, NW, SUITE 500, WASHINGTON, DC, 20005, US

(73) Assignees: Electronics and Telecommunications Research Institute, Daejeon (KR); Samsung Electronics Co., Ltd., Gyeonggi-do (KR)

(21) Appl. No.: 12/741,989

(22) PCT Filed: Jul. 29, 2008
(86) PCT No.: PCT/KR2008/004415

§ 371 Date: Jul. 23, 2010

(30) Foreign Application Priority Data
Nov. 9, 2007 (KR) 10-2007-0114275

(51) Int. Cl. G06F 21/24; G06F 15/16

(52) U.S. Cl. 726/28

(57) ABSTRACT

The present invention relates to the method and data sharing system which establishes an access right for data to share in pure or hybrid P2P environment and thus decides to open and share the data in accordance with which whether a recipient peer has the access right or not, thereby protecting the data from the access of the unspecified public and preventing the data from spreading in an improper manner. Also, since the existence of the data is not open to recipients with no having access right, the method and data sharing system according to the present invention has an effect of protecting the copyright and privacy of a data provider.

### TECHNICAL FIELD

The present invention relates to a data sharing system in peer to peer environment and a method thereof; and, more particularly, to a data sharing system and method in peer to peer environment, which setup access right for data through provider peers and enable predetermined recipient peers and recipient groups with access right to open and to share the data, thereby preventing data from being exposed to peers of the non-specific public.

This work was partly supported by the IT R & D program of MIC/IITA [1005-S-404-23, ‘3G Evolution Access System Development’].

### BACKGROUND ART

As information acquisition and data sharing through Internet has been booming, a peer-to-peer (P2P) service has emerged and thus data sharing activities have been spread more lively. In such P2P service, all the connected users can be data providers as well as data recipients by not only merely sharing data but also searching and sharing data stored in computers by interconnecting individual computers.

There are two types of P2P services. One is a hybrid P2P method in which data providers and data recipients are connected to a server, shared data is collected through the server, and information of a data provider is acquired through the server, thereby connecting individuals to share data. The other is a pure P2P method in which data providers and recipients share an address in advance for data sharing, for example, IP addresses, thereby directly accessing data using the address shared without a server.

In case of the hybrid P2P method, the server retrieves data that a recipient requests and transmits the information of a data provider and data access only, not to transmit real data. Here, when receiving the data provider or data access information from the server, the recipient directly connects to the provider using the information and receives the data, whereby after acquiring the data provider and data access information, data is shared through direct connection such as the pure P2P method. That is, the server retrieves the data that a certain user requests among a plurality of users and provides the results, that is, a provider who provides the data and only the information to access the data the provides has.

If a data provider sets up data to be shared regardless of the hybrid and pure P2P types, unspecified peers may access the data provider and access the corresponding data. Therefore, the data provider cannot designate or restrict a peer to receive the shared data. Also, the data provider cannot deny the data access by other peers.

### DISCLOSURE OF INVENTION

### Technical Problem

The present invention provides a data sharing system and method in peer to peer environment, which establish an access right for data to share and thus share the data or inform the absence of data in accordance with whether a recipient requesting the data has the access right or not, thereby protecting the data from the access of the unspecified public and preventing the data from spreading in an improper manner.

### Technical Solution

In accordance with an aspect of the present invention, there is provided a method of a data sharing system which includes: selecting content data to share and establishing an access right for the content data; deciding whether the recipient peer has the access right or not based on the access right established in the content data when a recipient peer requests the content data; and transmitting access information of the content data and thus providing the content data if the recipient peer has the access right.

In accordance with another aspect of the present invention, there is provided a method of a data sharing system, including: receiving information of content data and access right data which has been established for the content data from a provider peer having the content data; receiving a request to retrieve the content data from a recipient peer; judging whether the recipient peer has the access right or not based on the access right data; and if the recipient peer has the access right, transmitting information of the provider peer and access information of the content data.

In accordance with still another aspect of the present invention, there is provided a data sharing system which includes a provider peer for providing content data and a recipient peer for receiving the content data, wherein the provider peer establishes an access right for the content data and, when the recipient peer requests the content data, transmits the content data, corresponding to which the recipient peer has the access right or not.

The data sharing system may further include a server for relaying the connection of the provider peer and the recipient peer, wherein the server stores information of the content data received from the provider peer and the access right thereof, and provides information of the provider peer and access information of the content data to the recipient peer, if the recipient peer requests to retrieve the content data.

### ADVANTAGEOUS EFFECTS

The method and data sharing system according to the present invention establishes an access right for data to share in order to open the data only to recipients with the access right and to have them download the data whereby a data provider designates a recipient to share the data and thus restrict the data access of unspecified recipients. Therefore, the data is protected and prevented from spreading in an improper manner. Also, since the existence of the data is not open to recipients with no access right, the method and data sharing system according to the present invention has an effect of protecting the copyright and privacy of a data provider.

### BRIEF DESCRIPTION OF THE DRAWINGS

FIG. 1 is a diagram illustrating a structure of a P2P service in accordance with an exemplary embodiment of the present invention.

FIG. 2 is a block diagram illustrating a configuration of a peer which provides or receives data in P2P service environment in accordance with an exemplary embodiment of the present invention.

FIG. 3 is a block diagram illustrating a configuration of a server in P2P environment in accordance with an exemplary embodiment of the present invention.

FIG. 4 is a flowchart illustrating a method of establishing data sharing of a provider in accordance with an exemplary embodiment of the present invention.

FIG. 5 is a flowchart illustrating a data sharing method of a provider in a pure P2P mode in accordance with an exemplary embodiment of the present invention.

FIG. 6 is a flowchart illustrating a method of establishing sharer information of a server in accordance with an exemplary embodiment of the present invention.

FIG. 7 is a flowchart illustrating a data retrieving and data access information transmitting method of a server in accordance with an exemplary embodiment of the present invention.

FIG. 8 is a flowchart illustrating a data requesting and downloading method of a recipient in accordance with an exemplary embodiment of the present invention.

### BEST MODE FOR CARRYING OUT THE INVENTION

The advantages, features and aspects of the invention will become apparent from the following description of embodiments with reference to the accompanying drawings.

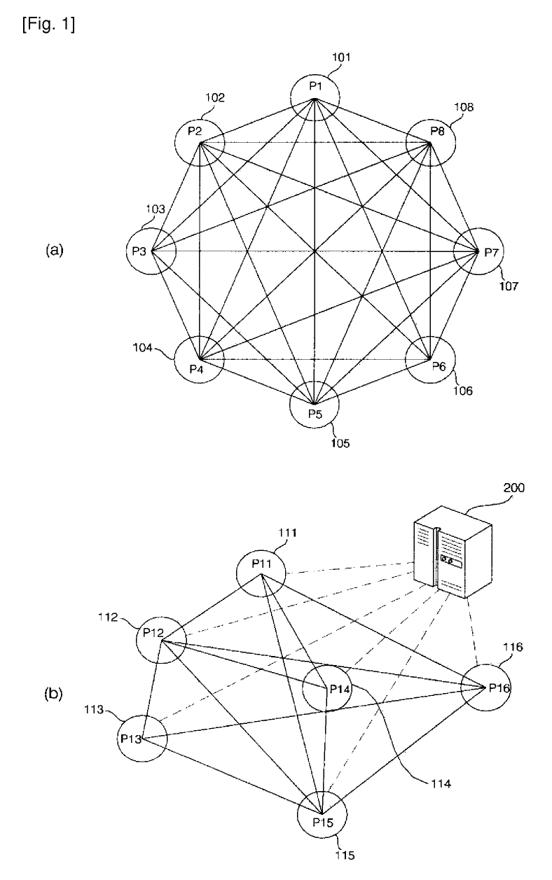

FIG. 1 is a diagram illustrating a structure of a P2P service according to the exemplary embodiment of the present invention. As shown therein, in the data sharing system according to the exemplary embodiment of the present invention, a plurality of peers interconnect each other in P2P service environment and share data.

(a) of FIG. 1 shows a network structure of a pure P2P service and (b) of FIG. 1 illustrates a network structure of a hybrid P2P service.

As in (a) of FIG. 1, a plurality of peers 101-108 in the pure P2P service interconnect each other, thus having a structure of a full mesh type. A first peer P1 101 can be directly connected to each of a second peer P2 to an eighth peer P8.

In the hybrid P2P service of (b) of FIG. 1, a hybrid P2P service structure includes a plurality of peers 111-116 that have data to share and request and receive data, and a server 200 which is connected to each of the peers 111-116 to provide data. Here, the peers provide the server 200 with data, and when data retrieval is requested by a predetermined peer, the server 200 retrieves data of all the connected peers using the information provided by the peer and supplies information of a peer having the requested data and data accesses. The plurality of peers connected to a P2P service may cover roles as a data provider and a data recipient which requests and receives data, and play a role between the two as desired at a certain moment.

Each peer of the pure or hybrid P2P type can be connected to all the peers, however each peer establishes an access right for data thereof, restricts peers that request access, and opens and shares data only to certain peers. If the access right is not established for data, all the peers are allowed to access the data.

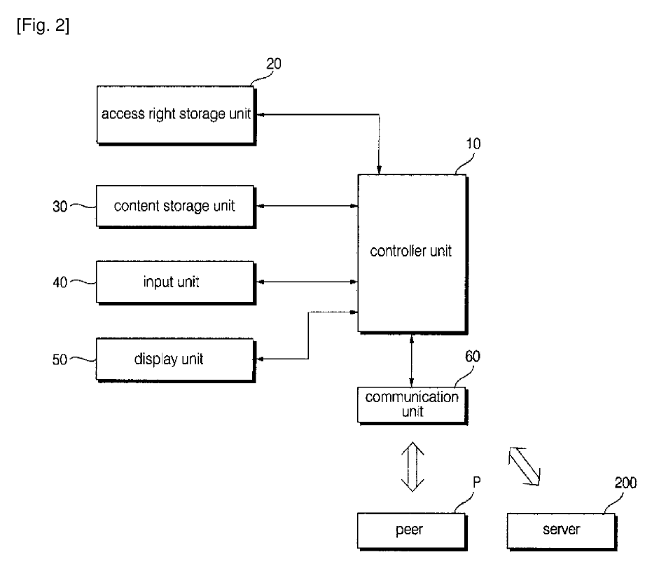

FIG. 2 is a block diagram illustrating a configuration of a peer which provides or receives data in P2P service environment according to the exemplary embodiment of the present invention.

As shown in FIG. 2, a peer includes a controller unit 10, an access right storage unit 20, a content storage unit 30, an input unit 40, a display unit 50, and a communication unit 60.

The content storage unit 30 stores a plurality of content data to share and also stores content data downloaded form other peers. Here, the content data stored in the content storage unit 30 are classified into data to be shared and not be shared in accordance with the establishment of the controller unit 10, and an access right is established for the data to be shared.

The access right storage unit 20 stores access right data which has been established by the controller unit 10 with respect to content data stored in the content storage unit 30. The access right storage unit 20 stores a list of sharers including information of recipient peers that are allowed to access the content data to share or a sharing condition, inclusive of a condition of a recipient peer having an access right as access right data. The access right storage unit 20 stores the list of sharers which has been generated from the server 200, corresponding to the sharing condition. The access right storage unit 20 stores access right data which have been matched to each of the content data to share.

The input unit 40 includes at least one button. The input unit 40 receives an order from a user corresponding to the works of the button and applies the order to the controller unit 10. The display unit 50 displays a screen corresponding to the user's order received through the input unit 40, outputs data received from other peer P and a connection state of other peer P, and outputs a transmitting state of the content data stored in the content storage unit 30.

The communication unit 60 connects other peers P in accordance with a control order of the controller unit 10 for thereby transmitting data upon the request of other peer P or receiving data from other peer P. Here, the received data are stored in the content storage unit 30. Also, under the hybrid P2P service, the communication unit 60 transmits information of the content data to share and its access right data to the server 200 and receives the list of sharers from the server 200 in accordance with the control order of the controller unit 10.

The controller unit 10 classifies the data stored in the content storage unit 30 into data to share and not to share, and establishes an access right for the content data to share. Here, corresponding to the user's order received from the input unit 40, the controller unit 10 establishes a list of sharers including recipient peers that are allowed to access and download each of the data or a sharing condition inclusive of a condition of a recipient peer as the access right and stores it in the access right storage unit 20. In case of the hybrid P2P mode, the controller unit 10 transmits a list of the content data to share and the access right data established in each of data to the server 200. Here, when the access right of the data list which has been transmitted to the server 200 includes the sharing condition, the controller unit 10 stores the list of sharers received from the server 200, corresponding to the sharing condition, in the access right storage unit 20.

The controller unit 10 executes a certain data sharing program and therefore connects to other peer P or to the server 200 through the communication unit 60, and performs a requested operation corresponding to the data transmitted. Especially, when the content data or the confirmation of the data existence is requested from other peer P, the controller unit 10 judges the access right for the peer which has requested the content data.

If the peer (hereinafter, ‘the recipient peer’) requesting the data has the access right, the controller unit 10 notifies the recipient peer there is the content data and transmits the access information of the content data requested through the communication unit 60. Also, when receiving a content data request from the recipient peer with the access information, the controller unit 10 transmits the content data to the recipient peer.

If the recipient peer has no access right, the controller unit 10 generates a message to notify the absence of data and transmits the message through the communication message 60. Here, the controller unit 10 decides whether the recipient peer is in the list of sharer for the data, or judges whether there is the access right or not in accordance with which whether the sharing condition is satisfied or not. Also, the controller unit 10 judges that there is the access right in a case where the information of the recipient peer exists in the list of sharers received from the server 200.

The controller unit 10 controls status data of a connecting condition of the recipient peer, data transmitting condition and the access right of the recipient peer to be outputted on the screen through the display unit 50.

When receiving content data from other peer P, the controller unit 10 requests through the communication unit 60 whether or not there is content data, based on the information of the peer having the content data. Here, the controller unit 10 downloads the content data and stores in the content storage unit 30 in accordance with the response from the peer having the data.

For the hybrid P2P, the controller unit 10 is connected with the server 200 through the communication unit 60 to request to retrieve the content data, for thereby collecting the information of the peer which has the content data and connecting the peer with the data in accordance with the collected information.

Here, since the plurality of the peers connected to the P2P service play roles as a provider peer and a recipient peer, the recipient peer has the same configuration as the provider peer. Therefore, it is noted that the same terms and figure numbers have been used for the same configuration.

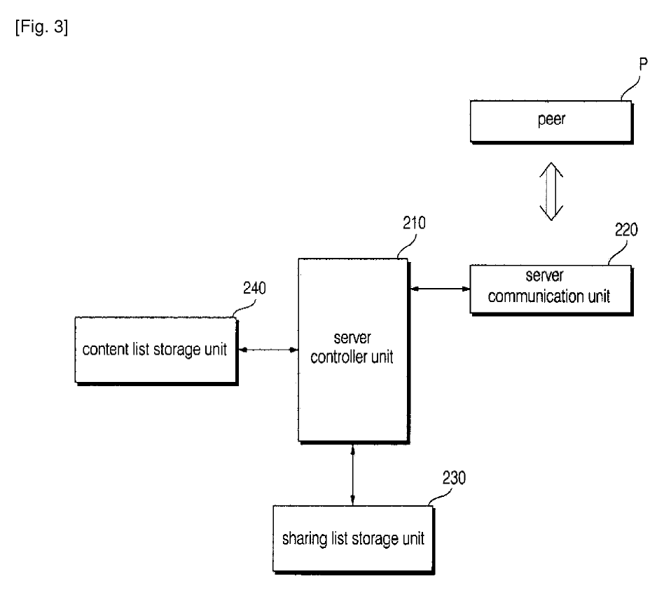

FIG. 3 is a block diagram illustrating a configuration of a server in P2P environment according to the exemplary embodiment of the present invention.

The server 200, in the hybrid P2P service, provides information of a peer which has content data and connection information of data so that a plurality of peers may connect each other. Here, the server 200 receives a list of content data each peer has from a peer P which provides the data and an access right thereof. And, the server 200 provides the information of data to the peer that has requested the content data, thereby having the peers interconnect each other.

As shown in FIG. 3, the server 200 includes a server controller unit 210, a content list storage unit 240, a sharing list storage unit 230, and a server communication unit 220.

The content list storage unit 240 stores a list of content data which is received from a plurality of peers through the server communication unit 220. Each peer P generates a list of content data to share and transmits the list to the server 200. The server controller unit 210 receives the data list by way of the server communication unit 220 and has it stored in the content list storage unit 240. At this time, the content list storage unit 240 does not store the actual content data, but only the list of content data, the information of a peer to provide the content data, and the access information of the data are stored therein.

The sharing list storage unit 230 stores data of an access right by data regarding the list of data stored in the content list storage unit 240. The access right by data is stored by mapping to the list of data which is stored in the content list storage unit 240, and the access right includes the list of sharers or a sharing condition of data.

When receiving the list of data and access right information of the data from the peer which has data, the server controller unit 210 retrieves a recipient peer that is suitable for a sharing condition and generates a list of sharers. Here, the list of sharers generated is stored in the sharing list storage unit 230 and, at the same time, it is transmitted to the peer having the corresponding content data through the server communication unit 220.

The server controller unit 210 retrieves the content data requested from the data list stored in the content list storage unit 240, corresponding to the retrieval request received from at least one peer P. When there is the content data that has been requested, the server controller unit 210 decides whether or not the peer which has requested the data has an access right in accordance with the access right of the data stored in the sharing list storage unit 230 and transmits the information of the data if the peer has the access right.

If the peer has no access right about the data, the server controller unit 210 transmits a message informing there is no data. If the requested data is provided by a plurality of peers, the server controller unit 210 judges an access right of a recipient peer about each data and transmits to the peer the information of the open data of which an access right has not been established.

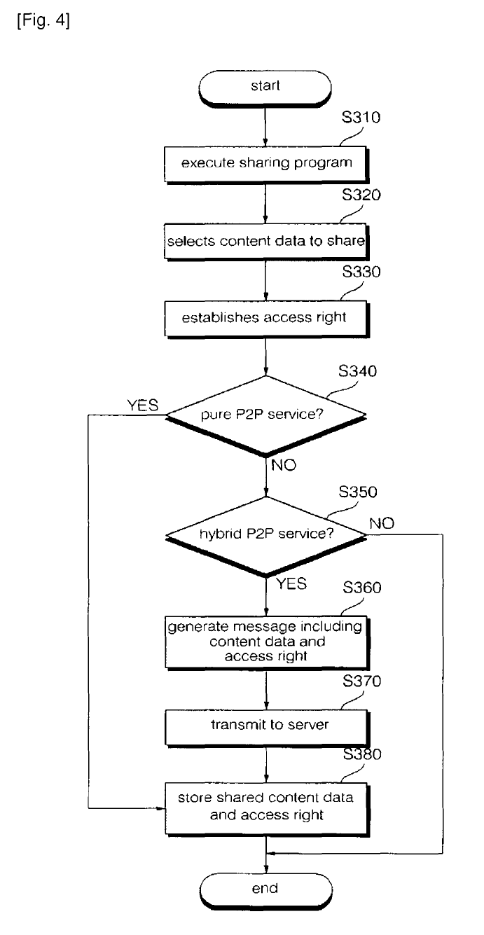

FIG. 4 is a flowchart illustrating a method of establishing data sharing of a provider according the exemplary embodiment of the present invention.

Referring to FIG. 4, a peer (hereinafter, ‘a provider peer’) which has data executes a sharing program at step S310, and selects content data to share among a plurality of content data the peer has at step S320, and establishes an access right for the content data to share at step S330.

For the content data to share, the provider peer establishes a list of sharers of recipient peers that may access the data. Here, the list of sharers includes at least one recipient peer and recipient peers can be established by groups. The information of recipient peers included in the list of sharers can be provided based on a directory stored in a terminal of the provider peer, email correspondents, and a list of members acquired from a certain community.

In addition, the provider peer is able to establish a sharing condition of a recipient peer that is accessible to the data as an access right. The sharing condition can be set on the basis of an IP address and/or an approach area of a recipient peer, also according to a characteristic of a recipient peer, the sharing condition can be provided on the basis of a specific age group, gender, occupation, and interest, etc.

When the provider peer is connected to a pure P2P service at step S340, the controller unit 10 of the provider peer stores the established access right, that is, the list of sharers or the sharing condition in the access right storage unit 20 by matching it to each data at step S380.

When the provider peer is connected to a hybrid P2P service at step S350, the controller unit 10 of the provider peer generates a message which includes a list data to share and an access right of each data included in the data list to inform the server of the content data to share at hand at step S360. The controller unit 10 of the provider peer transmits the generated message to the server 200 through the communication unit 60 5370, and stores the access right of the content data to share in the access right storage unit 20 at step S380.

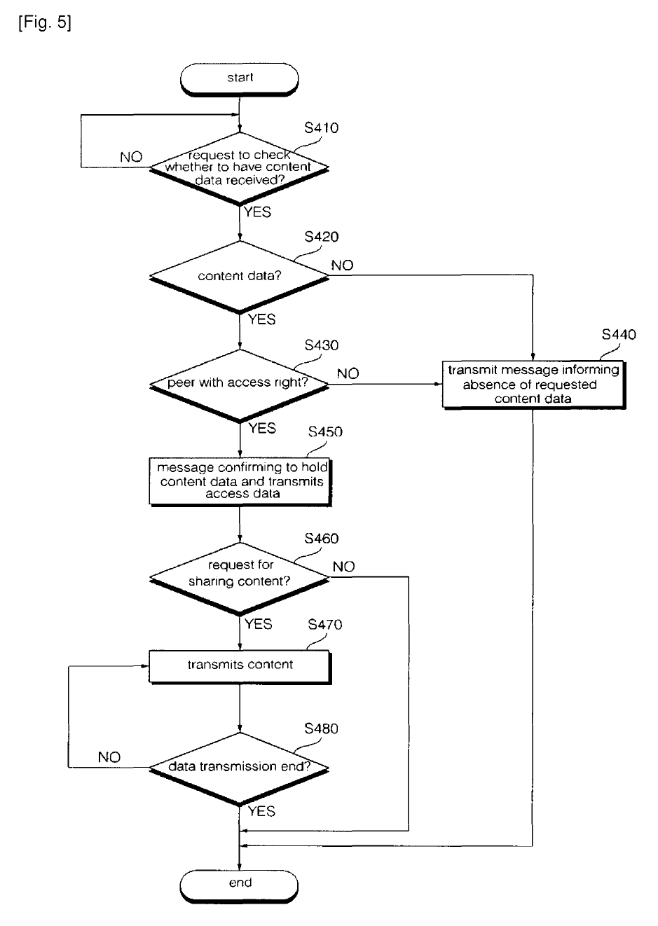

FIG. 5 is a flowchart illustrating a data sharing method of a provider in a pure P2P mode according to the exemplary embodiment of the present invention.

When the content data to share is selected and the access right of the data has been established, the provider peer starts data sharing when the recipient peer with the access right of the corresponding data requests so that the content data can be downloaded.

As shown in FIG. 5, in the pure P2P or hybrid P2P service, if the provider peer receives the request to check whether to have content data from the recipient peer to receive the content data at step S410, the provider peer retrieves the content data requested by the recipient peer from the content storage unit 30. Here, when having the content data at step S420, the provider peer calls out the access right data corresponding to the content data from the access right storage unit 20 and decides whether the recipient peer has the access right at step S430.

The controller unit 10 of the provider peer reads the list of sharers or the sharing condition included in the access right data of the access right storage unit 20 to decide whether the recipient peer has the access right, allowed to share the data, in accordance with which the recipient peer is included in the list of sharers or satisfied with the sharing condition. Here, for the hybrid P2P service, the provider peer judges the access right of the recipient peer, referring to the list of sharers which has been established by the provider peer and the list of sharers received from the server 200 regarding the sharing condition.

If requested content data does no exist or the recipient peer which requested the content data has no access right, the controller unit 10 of the provider peer generates a message informing absence of the requested content data and transmits the message to the recipient peer at step S440.

If the recipient peer has the access right to the content data requested, the controller unit 10 of the provider peer generates a message confirming to hold the content data and including information of the content data and transmits it to the recipient peer at step S450.

Corresponding to the transmitted message, when receiving the request to send the data from the recipient peer, the controller unit 10 of the provider peer connects the recipient peer through the communication unit 60, and transmits the data stored in the content storage unit 30 to the recipient peer at step S470. When the data transmission has been completed at step S480, the controller unit 10 releases the connection to the recipient peer.

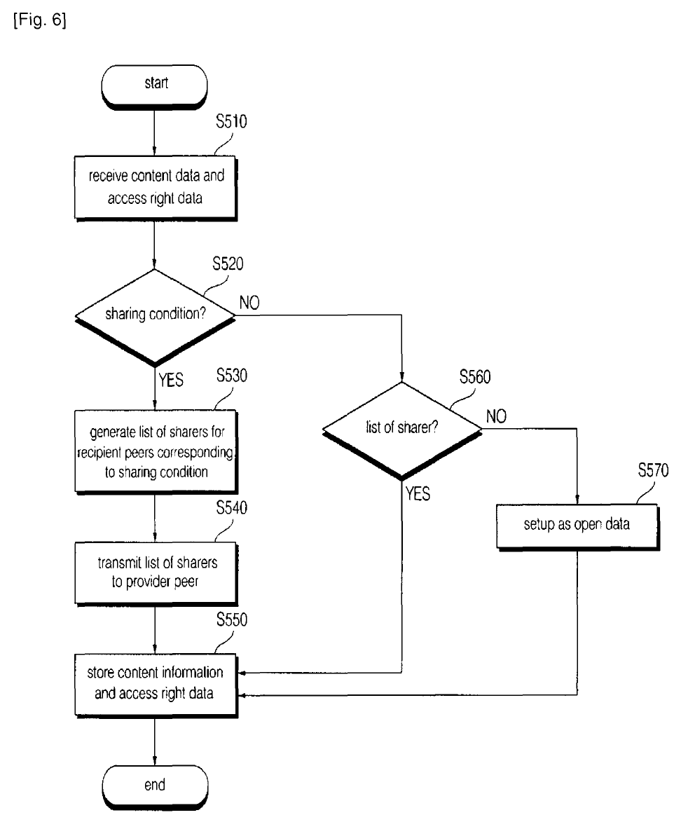

FIG. 6 is a flowchart illustrating a method of establishing sharer information of a server according to exemplary embodiment of the present invention.

Referring to FIG. 6, in the hybrid P2P service, the server 200 receives the list of data which includes the information of the content data to share with at least one provider peer and the access right data thereof at step S510.

The server controller unit 210 analyzes the list of data and access right data received from the server communication unit 220 and decides whether the access right data includes the sharing condition at step S520.

Here, if the access right data includes the sharing condition, the server controller unit 210 searches a recipient peer or a group of recipient peers that accord with the sharing condition for there by generating a list of sharers for the corresponding data at step S530. The list of sharers which has been generated is transmitted to the provider peer at step S540.

The server controller unit 210 stores the information of data included in the received list of data in the content list storage unit 240 together with the provider peer information at step S550, and stores the access right data corresponding to the data of the data list in the sharing list storage unit 230.

At this time, when the list of sharers is included in the access right data at step S560, the list of sharers is stored in the sharing list storage unit 230 without special establishment, and the list of sharers which has been generated in accordance with the sharing condition is stored in the sharing list storage unit 230. The server controller unit 210 regards data which has not access right as which they are open to a general run of peers, thereby setting up as open data at step S570.

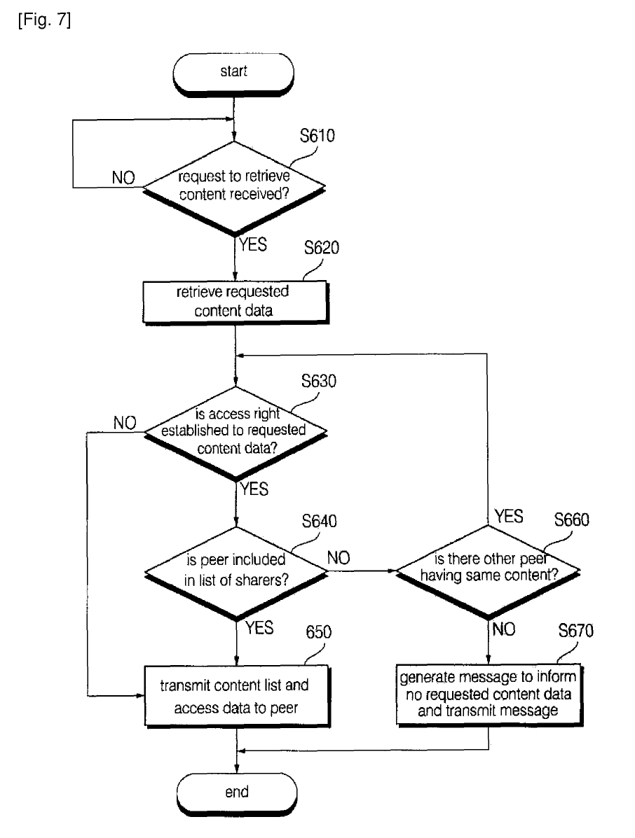

FIG. 7 is a flowchart illustrating a data retrieving and data access information transmitting method of a server according to exemplary embodiment of the present invention.

Referring to FIG. 7, when receiving a request to retrieve content from a recipient peer at step S610, the server 200 retrieves the content data from the content list storage unit 240 at step S620. When there is the requested content data, the server 200 calls out the access right data corresponding to the content data from the sharing list storage unit 230 and decides whether the access right has been established at step S630.

When the access right is established for the content data, the server 200 decides whether the recipient peer is included in the list of shares of the content data at step S630, and if the recipient peer is included in the list of sharers, the server 200 regards it as which the recipient peer is allowed to access the content data and thus transmits the information of the provider peer which has the content data and the connection information of the data to the recipient peer at step S650.

If the recipient peer has no access right for the requested data, the server 200 retrieves again whether there is other provider peer providing the same content at step S660. If there is more than one content data and the data is shared by the plurality of provider peers, it is judged whether the recipient peer has the access right for each of the data at steps S630 to S660.

Here, if there is no other provider peer to provide the same content or the recipient peer has no access right for the plurality of content data, the server 200 generates a message to inform there is no requested content data and transmits the message to the recipient peer at step S670.

While, if the access right is not established for the requested content data, meaning that the data is shared by a general run of recipient peers, the server 200 transmits the information of the provider peer having the content data and the connection information of the data to the recipient peer at step S650.

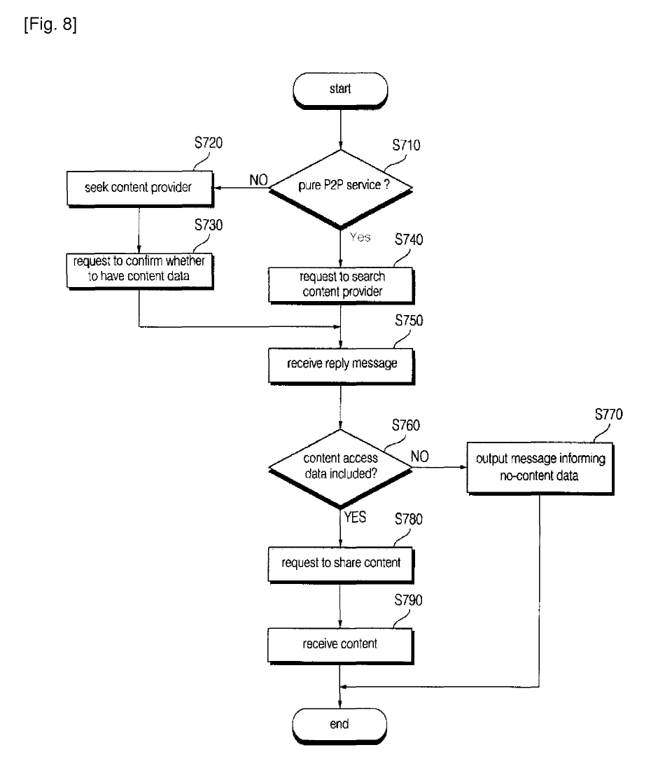

FIG. 8 is a flowchart illustrating a data requesting and downloading method of a recipient according to the exemplary embodiment of the present invention.

Referring to FIG. 8, when a certain content data is required, a user of a recipient peer requests the data to a provider peer which has the content data.

Here, when it is the pure P2P service at step S710, the user of the recipient peer seeks a provider peer to provide content data through a certain step at step S720. In order to seek the provider peer, the user of the recipient peer acquires the information of the provider peer making use of a procedure like service discovery, other communication means such as offline, phone calls, messengers, etc., or previously acquired knowledge. The recipient peer connects to the provider peer in accordance with the acquired information and requests to confirm whether to have the content data at step S730.

If receiving a reply message about the request, the recipient peer judges whether the reply message includes the access information of the content data at step S760. If the received message indicates only there is no content, the message informing there is not content data requested is outputted on a screen of a terminal at step S770.

If the received message includes the access information about the content data, the recipient peer connects to the provider peer according to the access information and requests the content data at step S780 and receives the data from the provider peer at step S790.

In case of the hybrid P2P service, the recipient peer connects to the server 200 and requests to retrieve content data which the recipient peer needs at step S740. When receiving a reply message from the server 200 at step S750, as in the pure P2P service, the recipient peer judges whether the reply message includes the access information of the content data at step S760, and then outputs a message informing there is no content at step S770, or connects to the provider peer in accordance with the access information and requests the content data at step S780 and receives the data from the provider peer at step S790.

Therefore, the method and data sharing system according to the present invention allow a certain recipient peer to receive data in accordance with an access right which has been established for data, for thereby preventing data from spreading by the unspecified public and helping to protect a provider peer with data.

### INDUSTRIAL APPLICABILITY

The method and data sharing system according to the present invention establishes an access right for data to share in order to open the data only to recipients with the access right and to have them download the data whereby data sharing among recipients with the access right can be activated and improper conduct of spreading data is prevent, for thereby having an effect of protecting the copyright and privacy of a data provider.

1. A method of a data sharing system, comprising:
selecting content data to share and establishing an access right for the content data;
deciding whether the recipient peer has the access right or not based on the access right established in the content data when a recipient peer requests the content data; and
transmitting access information of the content data and thus providing the content data if the recipient peer has the access right.

2. The method of claim 1, wherein in said establishing an access right, a list of sharers is generated to include at least one recipient peer which is able to access and share the content data.

3. The method of claim 1, wherein said establishing an access right, a sharing condition is generated to include a condition of at least one recipient peer which is able to access and share the content data.

4. The method of claim 3, wherein the sharing condition includes at least one of which the recipient peer has, such as an IP address, an area which the recipient peer accesses, a specific age group, gender, and occupation.

5. A method of a data sharing system, comprising:
receiving information of content data and access right data which has been established for the content data from a provider peer having the content data;
receiving a request to retrieve the content data from a recipient peer;
judging whether the recipient peer has the access right or not based on the access right data; and
transmitting information of the provider peer and access information of the content data if the recipient peer has the access right.

6. The method of anyone of claim 5, further comprising:
transmitting a message which informs absence of the content data, if the recipient peer has no access right.

7. The method of claim 5, further comprising:
if the access right data includes a sharing condition, retrieving a recipient peer which corresponds with the sharing condition, generating a list of sharers, and transmitting the list to the provider peer.

8. The method of claim 5, further comprising:
if the recipient peer has no access right after the step of judging whether the recipient peer has the access right or not, retrieving content data again which are provided by other provider peers; and
judging whether the recipient peer has an access right for each of the retrieved content data.

9. A data sharing system comprising:
a provider peer for providing content data; and
a recipient peer for receiving the content data,
wherein the provider peer establishes an access right for the content data and, when the recipient peer requests the content data, transmits the content data, corresponding to which the recipient peer has the access right or not.

10. The data sharing system of claim 9, further comprising:
a server for relaying the connection of the provider peer and the recipient peer, wherein the server stores information of the content data received from the provider peer and the access right thereof, and provides information of the provider peer and access information of the content data to the recipient peer, if the recipient peer requests to retrieve the content data.

11. The data sharing system of claim 10, wherein the provider peer includes:
a content storage means for storing the content data;
an access right storage means for storing access right data of the content data;
a communication means for transmitting the content data; and
a controller means for establishing an access right for the content data, and, if the recipient peer requests the content data, transmitting the content data to the recipient peer which has the access right after judging whether the recipient peer has the access right or not or generating and transmitting a message informing of absence of the content data when the recipient peer has no access right.

12. The data sharing system of claim 11, wherein the controller means establishes a list of sharers which includes at least one recipient peer which is able to access and share the content data or a sharing condition which includes a condition of the recipient peer as an access right and stores it in the access right storage means, and when the recipient peer is included in the list of sharers or satisfies the sharing condition, the controller means decides that the recipient peer has the access right.

13. The data sharing system of claim 10, wherein if the sharing condition is included in the access right data received from the provider peer, the server retrieves recipient peers which correspond to the sharing condition, generates and stores a list of shares, and transmits the list to the provider peer, and if an access right for the content data has not been established, it is regarded as which the data is open to the public and therefore the server opens the data to the public.

14. The data sharing system of claim 10, wherein if there is a plurality of provider peers providing the same data as the content data, the server judges the access right of the recipient peer for each of the content data and transmits access information of each content data.

15. The data sharing system of claim 10, wherein if the recipient peer has no access right, the server generates and transmits a message informing absence of the content data.

16. The data sharing system of claim 9, wherein the provider peer includes:
a content storage means for storing the content data;
an access right storage means for storing access right data of the content data;
a communication means for transmitting the content data; and
a controller means for establishing an access right for the content data, and, if the recipient peer requests the content data, transmitting the content data to the recipient peer which has the access right after judging whether the recipient peer has the access right or not or generating and transmitting a message informing of absence of the content data when the recipient peer has no access right.

17. The data sharing system of claim 16, wherein the controller means establishes a list of sharers which includes at least one recipient peer which is able to access and share the content data or a sharing condition which includes a condition of the recipient peer as an access right and stores it in the access right storage means, and when the recipient peer is included in the list of sharers or satisfies the sharing condition, the controller means decides that the recipient peer has the access right.
